(19) United States
(12) Patent Application Publication
(10) Pub. No.: US 2022/0281647 A1
(43) Pub. Date: Sep. 8, 2022

(54) EASY ACCESS CONTAINER

(71) Applicants: Stephen Almeida, Tampa, FL (US); James Kerr, Scarborough, ME (US)

(72) Inventors: Stephen Almeida, Tampa, FL (US); James Kerr, Scarborough, ME (US)

(21) Appl. No.: 17/193,879

(22) Filed: Mar. 5, 2021

(51) Int. Cl. B65D 41/04; B65B 69/00; A47J 47/08; B44D 3/12

(52) U.S. Cl. CPC B65D 41/04; B65B 69/00; A47J 47/08; B44D 3/127

(57) ABSTRACT

The current disclosure relates to containers. More specifically, the current disclosure relates to containers with access to both the top and the bottom of the container, particularly for contents of the container that are thick and/or viscous.

### FIELD OF DISCLOSURE

The current disclosure relates to containers. More specifically, the current disclosure relates to containers with access to both the top and the bottom of the container, particularly for contents of the container that are thick and/or viscous.

### BACKGROUND

The dispensing of products from containers, especially the dispensing of foodstuffs, and in particularly foodstuffs that are thick and/or viscous, from cans or jars, can be difficult as well as messy. This problem is exacerbated as the product gets removed from the container, and the only remaining product is on the bottom and walls of the container which is harder to reach and remove than product near the middle or top of the container.

One possible solution is to use a spoon, knife, spatula or other tool to extend to the bottom section of the container to scrape the remaining product from the bottom and lower walls of the container. However, this is often difficult, as well as dangerous. This is especially true if the lid has been removed using a can opener. The sharp edges of the container can result in injury while trying to removal the remaining amounts of the containers contents. Also, the reaching into the container to remove product at or near the bottom can be messy getting it smeared over the hands.

The problem has been addressed by widening the top screw cap of the container so that that the container sits upside down on the on top cap during storage. In this configuration, the top cap could be considered the bottom cap. The problem is that in many continents such as mustard, catsup and the like, a separation occurs, such as a clear liquid sits as a top layer of mustard such that bottle needs to be shaken to mix the separate layers.

When that happens, the contents coat the inside of the container and remain there until enough time has occurred that the contents slide down by gravity to fill the bottom, thus defeating the purpose of the upside-down container technology.

Also, all of the caps of these “upside-down” containers are small compared to the container itself lending instability to the container resulting in a tendency for the container to tip over.

Another possible solution is to utilize a push-up system. For example U.S. Pat. No. 8,079,499 to Juteau discloses a jar or bottle container for dispensing food items or other products, such container has a platform that is supported on a threaded post on the interior of the container. Turning a bottom portion of the container moves the platform up via a screwing motion to deliver product closer to the top opening.

In U.S. Pat. No. 10,865,034 to Beasley a complicated mechanism is disclosed in which a plunger is employed to push/pull the product from the bottom of the container to the top to gain access to the materials that were present at the bottom of the container.

Many of these solution are complicated, expensive and could be difficult to operate. The act of pushing or pulling and dispensing the bottom portion of the product can be time consuming. And with so many moving parts could be prone to breaking thus defeating the purpose of the invention.

There is a continuing need for a dispensing device for a container that allows a user to easily and rapidly remove the contents from a container. Desirably the dispensing device does not require separate tools for the removal of the contents.

### BRIEF DESCRIPTION OF FIGURES

FIG. 1 shows a sketch of the container of the current disclosure.

### SUMMARY OF EXEMPLARY EMBODIMENTS

The current application addresses the problems mentioned above. The application discloses inventive containers with access to both the top and the bottom of the container separately or at the same time, particularly for removal of contents of the container that are thick and/or viscous.

In a first embodiment, disclosed and claimed herein are container assemblies including a container having a hollow main body configured to be open at both ends of the container and an inner surface; and two enclosing devices that are configured to be removably attached to the open ends of the container and to enclose the hollow main body of the container. The enclosing devices are configured to be independently removable and reattachable.

In a second embodiment, disclosed and claimed herein are container assemblies of the above embodiment, wherein the enclosing devices comprise threading configurations to removably attach the enclosing devices to the ends of the container which are configured with complimentary threadings to accept the enclosing devices and enclose the container. The enclosing devices are configured to screw onto the ends of the container to result in an enclosed assembly.

In third embodiment, disclosed and claimed herein are container assemblies of the above embodiments wherein the container main body and the enclosing devices are made of the same or different materials and are comprised of metal, glass, paper, rubber, or combinations thereof.

In a fourth embodiment, disclosed and claimed herein are container assemblies of the above embodiments further comprising contents that are thick, viscous, or above their melt temperature.

In a fifth embodiment are method of removing materials from a container assembly, comprising, obtaining a container assembly of any of the above embodiments into which has been placed materials that are thick, viscous, or are above their melt temperature, removing one of the enclosing devices, removing some contents of the container, removing the other enclosing device, and removing the remainder of the contents by accessing the other end of the container assembly.

### DETAILED DESCRIPTION OF THE DISCLOSURE

The current disclosure presents container assemblies which are configured to have access to both ends of the container. The containers are generally a container having a hollow main body that open at both ends, top and bottom or one side and the other side. The containers bay be round, cylindrical, square, rectangular, or any other shape typical of a container for holding non-solid contents. The term non-solid refers to liquids, pastes, gels, jellies, materials that have a high viscosity, non-solid polymers, paints, or other materials which are above their melt temperature. The containers may be made from any material suitable for containing non-solid contents, such as, for example, glass, metals, treated cardboard, treated cardboard, polymer materials, such as, for example, polystyrene, polyethylene, polycarbonate and the like.

The open ends of the container are configured to accept lids, tops, covers, caps, or other enclosing device for enclosing containers. The devices may be made of the same materials as the container or they may be different. The mechanism by which the container and enclosing device removably attach may be screw threads so that the enclosing device screws onto the container to enclose it. In this embodiment the threaded enclosing device is in a female configuration. The ends of the main body of the container are configured to accept the threaded enclosing device with threads that are complimentary to the lid thread configuration, that is in a male configuration. In some configurations the ends of the main body of the container are configured in a male configuration. In operation the threaded enclosing device is placed over the ends of the threaded main body and screwed on to create a tight fit.

In other configurations, the enclosing device may be a cap that snaps onto the open end of the container which is configured to accept the snap on cap. Other embodiments include clips such as, for example, clips as used to enclose mason jars or beer bottles. In other embodiments either, or both, of the enclosing device may be permanently attached to the container. For example, a thin tab connecting the deice to container may be present such that when the device is opened the tab will allow the device to remain dangling from the container while allowing access to the inside of the container. Other devices for enclosing containers are known on the art and these few examples are intended as examples, and not meant to be restricting.

Also disclosed are methods of removing thick, viscous, materials above their melt temperature and materials that are difficult to containers when the volume of the materials are low. An example of such a material is peanut butter. Current containers for peanut butter are jars with screw lids. When most of the peanut butter is removed, removing the material at the bottom of the jar, as well as the sides of the jar is difficult, as most times knives use for spreading the peanut butter on bread is used to attempt to get at and remove the remaining peanut butter. Also, during this process, since there is always some peanut butter resided on the inside of the container, peanut butter gets all over the hand of the user. Other examples include mayonnaise, jelly, paint in paint cans, highly viscous polymers which generally require heating to lower the viscosity in order to pour out the remaining contents of the container but is a problem with heat sensitive materials. Methods presented in the current disclosure alleviate such issues.

One of the enclosing devices of the currently disclosed container assembly is remove, for example, the top, and material is removed. When enough material has been removed and it becomes difficult to remove the remaining material, the container may be turned over and the other enclosing device is removed and the remaining material is removed. In some embodiments the container may be laid on its side when the other enclosing device is removed.

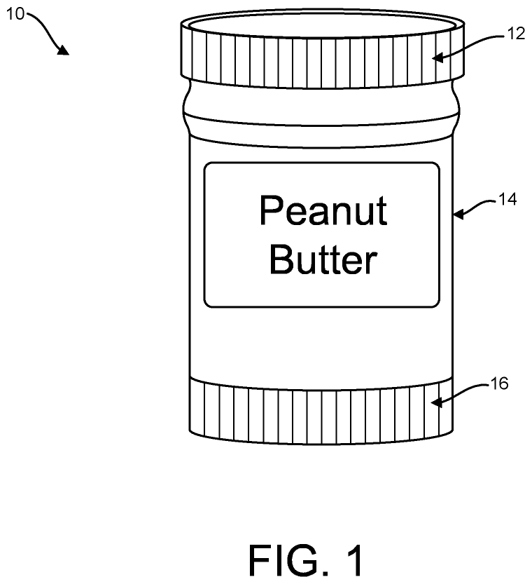

FIG. 1 shows a sketch of one embodiment of the current disclosure. A peanut butter jar 10, having a main hollow body 14, has an enclosing device 12 positioned on the top and an enclosing device positioned on the bottom. In operation the 12 is removed, in some embodiments by unscrewing the device, and contents are removed until such point that it becomes difficult and or messy to continue to try to remove any more materials. The bottom device 16 is then unscrewed, in this embodiment, and more or most or all of the remaining material is removed.

I claim:

1. A container assembly comprising:
a. container having a hollow main body configured to be open at both ends of the container and an inner surface; and
b. two enclosing devices that are configured to be removably attached to the open ends of the container and to enclose the hollow main body of the container,
wherein the enclosing devices are configured to be independently removable and reattachable.

2. The container assembly of claim 1, wherein the enclosing devices comprise threading configurations to removably attach the enclosing devices to the ends of the container which are configured with complimentary threadings to accept the enclosing devices and enclose the container.

3. The container assembly of claim 2, wherein the enclosing devices are configured to screw onto the ends of the container to result in an enclosed assembly.

4. The container assembly of claim 1, wherein the container main body and the enclosing devices are made of the same or different materials and are comprised of metal, glass, paper, rubber, or combinations thereof.

5. The container assembly of claim 1 further comprising contents that are thick, viscous, or above their melt temperature.

6. A method of removing materials from a container assembly, comprising:
a. obtaining a container assembly of claim 1 into which has been placed materials that are thick, viscous, or are above their melt temperature,
b. removing one of the enclosing devices,
c. removing some contents of the container,
d. removing the other enclosing device, and
e. removing the remainder of the contents by accessing the other end of the container assembly.

7. The method of claim 6 wherein the enclosing devices comprise threading configurations to removably attach the enclosing devices to the ends of the container which are configured with complimentary threadings to accept the enclosing devices and enclose the container.

8. The method of claim 7, wherein the enclosing devices are configured to screw onto the ends of the container to result in an enclosed assembly.
